(19) United States
(12) Patent Application Publication
(10) Pub. No.: US 2023/0267066 A1
(43) Pub. Date: Aug. 24, 2023

(54) SOFTWARE ANOMALY DETECTION

(71) Applicant: INTERNATIONAL BUSINESS MACHINES CORPORATION, ARMONK, NY (US)

(72) Inventors: Steven I. Ross, S Hamilton, MA (US); Stephanie Houde, Belmont, MA (US); Fernando Carlos Martinez, La Plata (AR); Hendrik Strobelt, Cambridge, MA (US)

(21) Appl. No.: 17/652,353

(22) Filed: Feb. 24, 2022

(51) Int. Cl. G06F 11/36; G06F 8/75

(52) U.S. Cl. CPC G06F 11/3616; G06F 8/75

(57) ABSTRACT

A method, computer system, and a computer program product for software anomaly detection is provided. The present invention may include, receiving a target source code including a sequence of tokens. The present invention may also include, determining a probability of a candidate token in the sequence of tokens based on a context of other tokens in the sequence of tokens. The present invention may further include, in response to the determined probability of the candidate token satisfying a low probability threshold, detecting a low probability region in the received target source code, wherein the detected low probability region is associated with the candidate token satisfying the low probability threshold.

### BACKGROUND

The present invention relates generally to the field of computing, and more particularly to software anomaly detection.

Software includes a collection of programs or instructions that are configured to direct a computer to perform various tasks. Software development typically refers to the process of creating, designing, deploying, and supporting software. One of the most important aspects of the software development process is the assurance software quality and reliability.

### SUMMARY

Embodiments of the present invention disclose a method, computer system, and a computer program product for software anomaly detection. According to one embodiment, the present invention may include, receiving a target source code including a sequence of tokens. According to one embodiment, the present invention may also include, determining a probability of a candidate token in the sequence of tokens based on a context of the other tokens in the sequence of tokens. According to one embodiment, the present invention may further include, in response to the determined probability of the candidate tokens satisfying a low probability threshold, detecting a low probability region in the received target source code, wherein the detected low probability region.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is a schematic block diagram of an anomaly detection environment according to at least one embodiment;

FIG. 3 is an operational flowchart illustrating a process for anomaly detection according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for detecting anomalies in software. As such, the present embodiment has the capacity to improve the technical field of software development by implementing a machine learning-based language model to automatically detect anomalies in one or more source code of a computer program.

According to one embodiment, source code may refer to any human-readable programming language that may be used as input to produce an executable program. In some embodiments, source code may be transformed into machine code (e.g., by a compiler) which may then be executed by a computer. In other embodiments, source code may be interpreted (e.g., by an interpreter) and immediately executed. In some implementations, source code may be written as plain text and stored as text files.

More specifically, an anomaly detection program may be based on a trained machine learning language model that has been trained on examples of good source code. In some embodiments, the anomaly detection program may implement the trained machine learning model to compute the probability of individual tokens in the source code of a program under evaluation. In some embodiments, the anomaly detection program may indicate regions of low probability tokens for further inspection by the user. In some embodiments, the anomaly detection program may also present alternative token sequences with higher probability tokens as suggested replacements for the low probability regions.

According to one embodiment, a token in programming language may refer to the smallest individual unit of a program. In some implementations, the statements and instructions inside a program may be divided up into tokens. Examples of tokens in programming may include, for example, keywords, identifiers, literals, operators, and/or punctuators.

According to one embodiment, the trained machine learning model described in the present disclosure may refer to a language model, and more specifically, to a generative language model trained using a transformer model architecture. In some embodiments, the generative language model may use the distribution of a dataset to return a probability for a given example. In some embodiments, the generative language model may generate new samples from the same distribution. In embodiments of the present disclosure, the generative language model may assign a probability value to a sequence of tokens in a source code. In embodiments of the present disclosure, the generative language model may generate alternative tokens based on the distribution of the sequence of tokens in the source code.

As described previously, one of the most important aspects of the software development process is the assurance of software quality and reliability. From a historical context, software failures have had extremely serious consequences. Accordingly, in order to decrease the high cost of software maintenance and the risk of software failure, software developers spend a great deal of time inspecting source code for errors, bugs, weaknesses, and/or other issues during the software development process.

Inspecting source code for errors and other symptoms of poorly designed code is a labor-intensive process. Errors generally fall into one of two categories: syntax errors and semantic errors. Syntax errors may be detected for code that is invalid according to the grammar of a programming language. Generally, compilers may detect syntax errors and prevent the code from compiling until the error is fixed. On the other hand, semantic errors may occur when the code is syntactically valid, but may not produce the intended output due to an error in logic. Since compilers are designed to enforce grammar and not intent, a majority of semantic errors may not be detected by existing compilers. In addition to syntax and semantic errors, code smells and anti-patterns may also indicate weaknesses in the source code. Code smells may refer to code that is technically correct, but includes certain characteristics that violate fundamental design principles which may negatively impact software quality. Anti-patterns may refer to commonly-used responses to existing problems that provide risky solutions and may be counterproductive. Further, source code that does not follow coding conventions, best practices, and standards may also increase the risk of failures and costly maintenance in the future.

Manual inspection for all the above-identified issues may be cost and/or time prohibitive. This is especially true as software products and services become more complex, with millions of lines of code. Existing static analysis tools may also be insufficient because these tools rely on rules (e.g., anti-patterns) to be manually defined. In other words, existing static analysis tools need specifically curated examples and descriptions of what not to do when coding.

Therefore, it may be advantageous to, among other things, provide a way to train a machine learning model on high-quality source code such that the trained model may be implemented to automatically recognize when source code deviates from that high-quality source code standard.

According to one embodiment, the anomaly detection program may be implemented as an add-on to a software development tool and/or Integrated Development Environment (IDE) that may detect regions of programming language code (e.g., source code) containing deviations (e.g., errors, code smells, anti-patterns, style) from high-quality code.

According to one embodiment, the anomaly detection program may implement the region detection based on computing the probability of the programming language code using a generative language model.

According to one embodiment, the anomaly detection program may visually highlight low probability regions of the programming language code on demand for the developer.

According to one embodiment, the anomaly detection program may generate alternative higher probability instantiations of the low probability regions of the programming language code on demand for the developer.

According to one embodiment, the anomaly detection program may enable the generated alternatives to be selected by the developer and substituted for the original instantiation of low probability region to modify the programming language code under review.

Additionally, or alternatively, the present disclosure may also include, determining a probability of each token in the sequence of tokens based on a context of the other tokens in the sequence of tokens. According to one embodiment, the present disclosure may further include, in response to the determined probability of the one or more tokens (e.g., consecutive tokens) satisfying a low probability threshold, detecting a low probability region in the received target source code, wherein the detected low probability region may be highlighted to a user as an area of the code meriting further inspection.

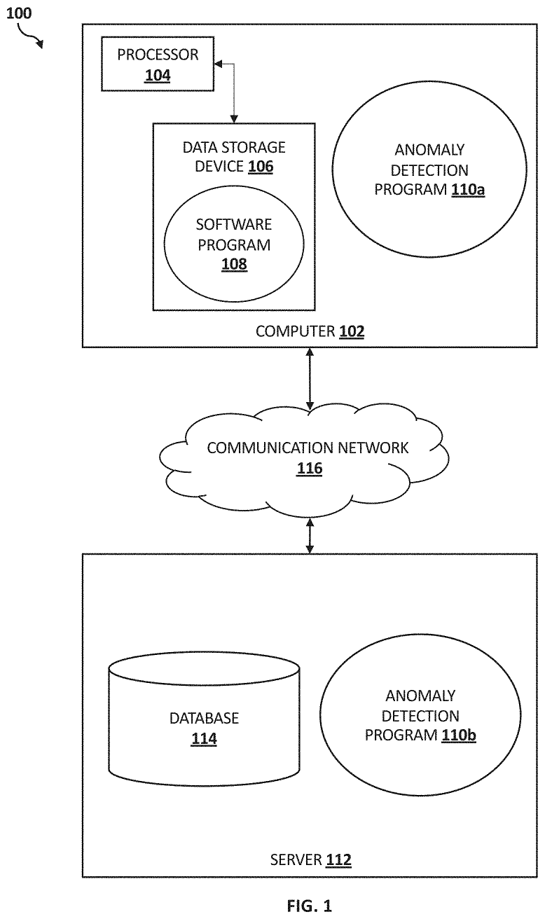

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an anomaly detection program 110a. The networked computer environment 100 may also include a server 112 that is enabled to run an anomaly detection program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

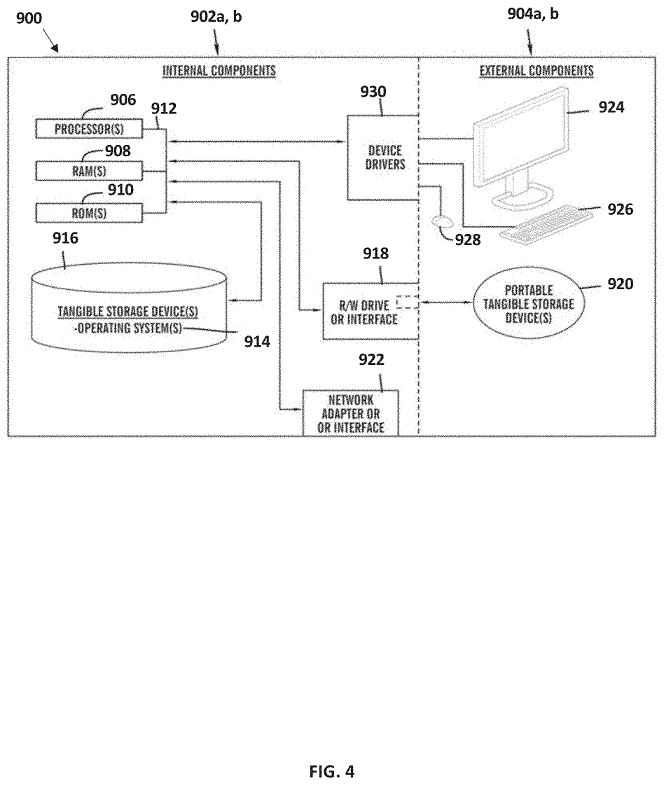

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the anomaly detection program 110a, 110b may interact with a database 114 that may be embedded in various storage devices, such as, but not limited to a computer/mobile device 102, a networked server 112, or a cloud storage service.

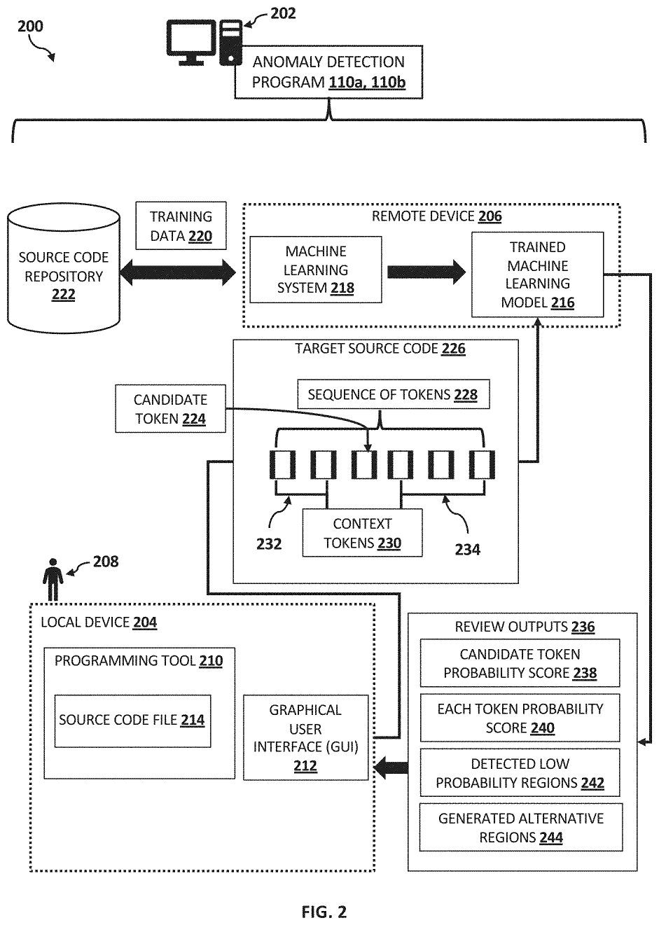

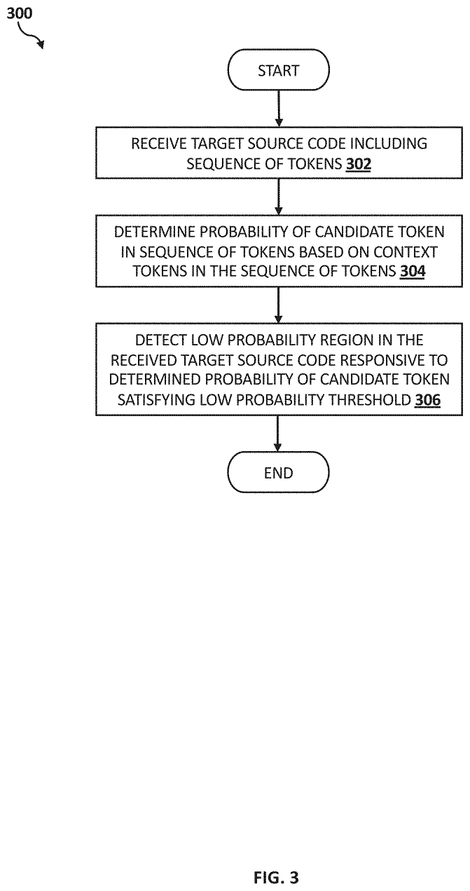

According to the present embodiment, a user using a client computer 102 or a server computer 112 may use the anomaly detection program 110a, 110b (respectively) to train a machine learning model (using self-supervised learning) to recognize the patterns and qualities of high-quality source code and detect if/when a source code under evaluation deviates from that high-quality standard. The disclosed embodiments are explained in more detail below with respect to FIGS. 2 and 3.

Referring now to FIG. 2, a schematic block diagram of an anomaly detection environment 200 implementing the anomaly detection program 110a, 110b according to at least one embodiment is depicted.

According to one embodiment, the anomaly detection environment 200 may include one or more components (e.g., client computer 102; server computer 112; communication network 116) of the computer environment 100 discussed above with reference to FIG. 1.

According to one embodiment, the anomaly detection environment 200 may include a computer system 202 having a tangible storage device and a processor that is enabled to run the anomaly detection program 110a, 110b. In one embodiment, the computer system 202 may include at least one local device 204 (e.g., client computer 102) and at least one remote device 206 (e.g., server computer 112). In various embodiments, the local device 204 and/or the remote device 206 of the computer system 302 may include a workstation, a personal computing device, a laptop computer, a desktop computer, a computing server, a thin-client terminal, a tablet computer, a smartphone, a smart watch or other smart wearable device, or other electronic devices. In at least one embodiment, the remote device 206 may also operate in a cloud computing service model, such as Software as a Service (SaaS), Platform as a Service (PaaS), or Infrastructure as a Service (IaaS). In one embodiment, the remote device 206 may also be located in a cloud computing deployment model, such as a private cloud, community cloud, public cloud, or hybrid cloud.

In one embodiment, the anomaly detection program 110a, 110b may include a single computer program or multiple program modules or sets of instructions being executed by the processor of the computer system 202. The anomaly detection program 110a, 110b may include routines, objects, components, units, logic, data structures, and actions that may perform particular tasks or implement particular abstract data types. The anomaly detection program 110a, 110b may be practiced in distributed cloud computing environments where tasks may be performed by local and/or remote processing devices which may be linked through the communication network 116. In one embodiment, the anomaly detection program 110a, 110b may include program instructions that may be collectively stored on one or more computer-readable storage media. As such, in various embodiments, a first instance of the anomaly detection program 110a, 110b may be implemented in the local device 204 and a second instance of the anomaly detection program 110a, 110b may be implemented in the remote device 206.

According to one embodiment, the local device 204 may be associated with a user 208. In one embodiment, the user 208 may include, for example, programmers, software engineers, and/or software developers. In some implementations, the user 208 may also include anyone that interacts with the local device 204 to create software code. In some embodiments, the various personas of the user 208 may be referred to as a developer and/or a software developer. Similarly, in some implementations, the local device 204 may be referred to as a developer device.

According to one embodiment, the local device 204 may include a programming tool 210 which the user 208 may interact with to create, debug, maintain, and/or support a computer software. In some implementations, the programming tool 210 may include a source code editor which the user 208 may interact with to write the source code of a computer program. In some implementations, the programming tool 210 may also include a complier and/or an interpreter, which may be used to transform the source code into machine language for execution by a computer. In some embodiments, the various functionalities of the programming tool 210 may be provided as discreet programs. In other embodiments, the various functionalities of the programming tool 210 may be provided as part of an integrated development environment (IDE). In at least one embodiment, the anomaly detection program 110a, 110b may be provided as a discreet program from the programming tool 210. In some implementations, the anomaly detection program 110a, 110b may be provided as part of the IDE.

According to one embodiment, the local device 204 may include a graphical user interface (GUI) 212 which may be executed by the local device 204 to present (e.g., output) graphical and/or textual data on a display associated with the local device 204. In one embodiment, the GUI 212 may interact with the programming tool 210 and/or the anomaly detection program 110a, 110b to display corresponding graphical and/or textual data on the display associated with the local device 204. In some implementations, the user 208 may interact with the programming tool 210 using the GUI 212 to create (e.g., write) source code into a source code file 214. In some embodiments, the source code file 214 may refer to a human readable text file including source code associated with any computer programming language. In some implementations, the source code in the source code file 214 may include high-level programming language, including, but not limited to, Smalltalk, Python, Java, JavaScript, Ruby, C/C++, C #, Objective-C, SQL, PHP, and/or R.

According to one embodiment, as part of the software development process, the user 208 may need to inspect the source code in source code file 214 for anomalies, such as, for example, errors, bugs, weaknesses, and/or other issues. In some implementations, due to the complexity and/or size of the source code file 214, it may be nearly impossible and/or ineffective for the user 208 to manually inspect the source code. Existing static software analysis tools may also be insufficient because these tools work by applying rules (e.g., descriptions of what not to do when coding) to assess the source code. These rules, which need to be manually defined, may be programming language-specific and/or operating-system specific. Further, the number of corrections detected by these static software analysis tools may depend on the number of rules that were defined in the tool.

Aspects of the present disclosure relate to implementing the anomaly detection program 110, 110b to automatically improve the quality of a target source code based on a machine learning model that is trained on examples of high-quality source code. Thus, the anomaly detection program 110a, 110b may extend beyond detecting syntax and other common programming errors. In some implementations, the anomaly detection program 110a, 110b may employ a trained machine learning (ML) model 216 to detect anomalies, such as, for example, semantic errors, code smells, anti-patterns, violation of coding conventions, violation of coding standards, and/or violation of best practices

According to one embodiment, the anomaly detection environment 200 may include a machine learning (ML) system 218 which may be implemented by the anomaly detection program 110a, 110b to generate the trained ML model 216.

In some embodiments, the ML system 218 may be implemented in the remote device 206. In at least one embodiment, the remote device 206 may include a computing server or a cloud service hosting the ML system 218 as an Artificial Intelligence (AI) platform. In some implementations, the ML system 218 may process large volumes of data to generate the trained ML model 216. In some implementations, the ML system 218 may be trained with training data 220 derived (e.g., accessed) from a source code repository 222. In some embodiments, the source code repository 222 may include a database and/or corpus of knowledge storing examples of high-quality source code of a program written in one or more programming languages.

According to one embodiment, the ML system 218 may look for, and determine, patterns, or lack thereof, in the training data 220, may “learn” from the patterns in the training data 220, and may ultimately accomplish tasks without being given specific instructions. In addition, the ML system 218 may implement neural networks that can demonstrate learning behavior by performing tasks that are not explicitly programmed. In some implementations, neural networks may be configured to model the operation of a nervous system. As such, basic units may be referred to as neurons, which may be organized into layers. In some implementations, the neural network may work by simulating a large number of interconnected processing devices that resemble the nervous system. In some implementations, a neural network may include three parts: an input layer, with units representing input fields, one or more hidden layers, and an output layer, with a unit or units representing target field(s). In some embodiments, the units may be connected with varying connection strengths or weights. Input data may be presented to the first layer, and values may be propagated from each neuron to every neuron in the next layer. In some implementations, each layer of the neural network may include one or more operators or functions operatively coupled to output and input. Output from the operator(s) or function(s) of the last hidden layer may be referred to herein as activations. Eventually, a result may be delivered from the output layers.

Deep learning is a type of neural-network in which the ML system 218 may accomplish complex tasks by implementing successive layers to learn from the training data 220 in an iterative manner. According to one embodiment, the ML system 218 may implement deep learning using a transformer model architecture. In some implementations, the transformer model architecture may include a self-attention technique which is configured to relate different positions of a single sequence in order to compute a representation of the sequence.

According to one embodiment, ML system 218 may include various learning styles. In some implementations, one such learning style may include self-supervised learning. In some embodiments, self-supervised learning may seek to solve for the time-consuming and expensive task of manually labeling datasets (e.g., training data 220) for new tasks. Instead, with self-supervised learning, the ML system 218 may train itself by leveraging one part of the input data to predict another part of the input data and generate labels accordingly, thereby eliminating the necessity of manual data labeling. In some implementations, self-supervised learning may leverage the underlying structure of the input data (e.g., training data 220) to predict any unobserved or hidden part of the input from any observed or unhidden part of the input.

As described previously, the ML system 218 may be trained with training data 220 derived (e.g., accessed) from the source code repository 222. In some embodiments, the source code repository 222 may include a database and/or corpus of knowledge storing examples of high-quality source code of a program written in one or more programming languages. In some implementations, the source code repository 222 may include a filter configured to identify high-quality source code examples. In one embodiment, the filter configured to identify high-quality source code examples may be based on crowd-sourced ratings associated with the quality of the code. One example of a source code repository 222 which may be accessed for training data 220 may include GITHUB® (GITHUB and all GITHUB-based trademarks and logos are trademarks or registered trademarks of GitHub, Inc. and/or its affiliates). Additionally, or alternatively, other examples of source code repository 222 including high-quality source code examples may also be implemented to access training data 220.

According to one embodiment, the high-quality source code may represent positive examples of source code. Thus, in some embodiments, the self-supervised learning techniques implemented by the ML system 218 may leverage the underlying structure of positive examples of source code (e.g., input; training data 220) to predict any unobserved or hidden part of the input from any observed or unhidden part of the input.

According to one embodiment, the training data 220, including high-quality source code, may represent sequential data, such as, for example, a sequence of source code tokens. In some implementations, the smallest unit of a source code text may be referred to as a token. It is contemplated that all statements and instructions inside of a program may include various types of tokens. A non-exhaustive list of tokens may include, for example, keywords, identifiers, literals, operators, and/or punctuators.

According to one embodiment, during the training process, the ML system 218 may implement an auto-regressive language modeling technique (e.g., category of self-supervised learning). More specifically, in some embodiments, the ML system 218 may tokenize the source code in the training data 220 and implement a learning task to mask (e.g., hide) and predict a next token in a sequence of tokens, given a previous (e.g., preceding) number of tokens in the sequence of tokens (e.g., reading the source code left to right). In some implementations, the previous number of tokens may provide a context for predicting the next token. Since the next token in the sequence of tokens is known from the training data 220, the ML system 218 may determine if the prediction is correct based on unmasking the next token. Accordingly, a prediction model may be trained without manually-annotated training data 220. In some implementations, the ML system 218 may implement a learning task to mask (e.g., hide) and predict a previous token in a sequence of tokens, given a future (e.g., succeeding) number of tokens in the sequence of tokens (e.g., reading the source code right to left). In some implementations, the future number of tokens may provide a context for predicting the previous token.

According to one embodiment, during the training process, the ML system 218 may also implement a masked language modeling technique (e.g., category of self-supervised learning). Under the masked language modeling technique, the ML system 218 may tokenize the source code in the training data 220 and implement a learning task to mask (e.g., hide) and predict one or more random token in a sequence of tokens, given a context of both previous and next tokens in the sequence of tokens.

According to one embodiment, the trained ML model 216 generated by the ML system 218 may include a language model, where the language may refer to one or more programming languages. In one embodiment, the ML system 218 may generate a discreet trained ML model 216 for each of various types of programming languages. In some embodiments, the ML system 218 may generate a single trained ML model 216 for the various types of programming languages. In some embodiments, the ML system 218 may generate multiple trained ML models 216, where each trained ML model 216 may be configured for predicting one or more programming languages.

According to one embodiment, the language model represented by the trained ML model 216 may be executed to determine (e.g., estimate) a probability of a candidate token 224 in a target source code 226. In some implementations, the probability may be determined in accordance with a distribution of a sequence of tokens 228 and based on one or more context tokens 230 in the sequence of tokens 228. In one embodiment, the context tokens 230 may include one or more preceding tokens 232 and/or succeeding tokens 234 (e.g., other tokens relative to the candidate token 224).

According to one embodiment, the ML system 218 may be implemented in the local device 204 associated with the user 208. In such implementations, the local device 204 may retrieve the training data 220 from the source code repository and the ML system 218 running on the local device 204 may generate the trained ML model 216 (e.g., language model), as described above with reference to the implementation using the remote device 206.

According to one embodiment, once the trained ML model 216 is deployed, the anomaly detection program 110a, 110b may implement the trained ML model 216 to detect anomalies in the target source code 226. In some implementations, the trained ML model 216 may receive the target source code 226 including the sequence of tokens 228. In one embodiment, the user 208 may interact with the programming tool 210 (e.g., via GUI 212) and select one or more sections of the source code file 214 for a review request. In one embodiment, the anomaly detection program 110a, 110b may detect the selected source code from the source code file 214 as the target source code 226 for the review request. In one embodiment, the detected selection from the source code file 214 may be automatically transmitted to the trained ML model 216 for analysis. In some embodiments, the user 208 may select the entire source code file 214 for review. In such embodiments, the target source code 226 may include the entire source code file 214.

According to one embodiment, the target source code 226 may be analyzed to determine the sequence of tokens 228, as described previously. In some embodiments, the anomaly detection program 110a, 110b may transform (e.g., tokenize) the target source code 226 into the sequence of tokens 228. Then, according to one embodiment, in response to the trained ML model 216 being presented with a first N number of tokens in the sequence of tokens 228, the trained ML model 216 may generatively compute the probabilities of one or more potential next tokens. In some implementations, the potential next token may include the candidate token 224, where the trained ML model 216 may compute the probability of the candidate token 224 based on the preceding tokens 232 (e.g., first N tokens) in the sequence of tokens 228. Additionally, or alternatively, the trained ML model 216 may compute the probability of the candidate token 224 based on the succeeding tokens 234 in the sequence of tokens 228. In some implementations, the preceding tokens 232 and/or the succeeding tokens 234 may be referred to as the context tokens 230.

According to one embodiment, the anomaly detection program 110a, 110b may implement the trained ML model 216 to determine the probability of each token in the sequence of tokens 228 based on the context of other tokens (e.g., context tokens 230) in the sequence of tokens 228. In some implementations, each token in the sequence of tokens 228 may be referred to as the candidate token 224 as the probability of the corresponding token is being determined. In some embodiments, the anomaly detection program 110a, 110b may implement the trained ML model 216 to compute the probability of each token successively, in the sequence of tokens 228. By computing the probability of each token successively, the trained ML model 216 may determine the probabilities for all of the tokens in the source code file 214.

Although the trained ML model 216 may compute the probability of each token successively (as described above), according to at least one embodiment, the trained ML model 216 may compute the probability of the tokens in the sequence of tokens 228 in any order. In another embodiment, the trained ML model 216 may compute the probability of multiple tokens in the sequence of tokens 228 at the same time. In such embodiments, the candidate token 224 may include multiple tokens.

As described previously, the trained ML model 216 may include a language model trained on examples of high-quality source code (e.g., training data 220). Accordingly, in some implementations, the trained ML model 216 (e.g., language model) may include an expectation regarding the patterns that are typically present in high-quality source code. In some implementations, as the trained ML model 216 analyzes the sequence of tokens 228, the trained ML model 216 may anticipate what the candidate token 224 should be based on the language model. In some implementations, if the candidate token 224 that is encountered in the sequence of tokens 228 is especially divergent from expectations of the trained ML model 216 (e.g., anticipated token is different from candidate token 224), the trained ML model 216 may detect a low probability region in the sequence of tokens 228 of the target source code 226.

According to one embodiment, the trained ML model 216 may detect the low probability region in the sequence of tokens 228 based on the determined probability of the candidate token 224 satisfying a low probability threshold. According to one embodiment, the low probability threshold may be satisfied if the determined probability is less than the mean probabilities of tokens in the sequence of tokens 228 or in a section of the source code file 214. In some implementations, the anomaly detection program 110a, 110b may keep track of a range of probabilities of tokens in the sequence of tokens 228 or in a section of the source code file 214 and highlight regions that are substantially lower than the mean probabilities in the sequence of tokens 228 or in a section of the source code file 214 as satisfying the low probability threshold.

In some embodiments, the low probability threshold may be satisfied by the determined probability of the candidate token 224 ranging from 0.00 to 0.50. In some embodiments, the low probability threshold may be satisfied by the determined probability of the candidate token 224 ranging from 0.00 to 0.70. In some embodiments, the low probability threshold may be satisfied by any other probability score and/or range of probability scores of the candidate token 224. In some embodiments, the low probability threshold may be defined by the user 208 interacting with the programming tool 210 and/or the anomaly detection program 110a, 110b. In some embodiments, the low probability threshold may be defined based on the level of programming experience of the user 208. In one embodiment, the low probability threshold may be associated with a confidence score of the candidate token 224. Additionally, or alternatively, the trained ML model 216 may detect the low probability region in the sequence of tokens 228 based on the determined probability of multiple tokens (e.g., one or more consecutive tokens) in the sequence of tokens 228 satisfying the low probability threshold.

According to one embodiment, the anomaly detection program 110a, 110b may generate one or more types of review outputs 236 for the user 208 (e.g., developer) on demand, based on the analysis of the trained ML model 216. In some implementations, the review outputs 236 may be received by the local device 204 and presented to the user 208 via the GUI 212. In one embodiment, the review outputs 236 may include a candidate token probability score 238. Additionally, or alternatively, the review outputs 236 may include each token probability score 240. Additionally, or alternatively, the review outputs 236 may include one or more detected low probability regions 242. Additionally, or alternatively, the review outputs may include one or more generated alternative regions 244, as will be detailed further below.

According to one embodiment, the anomaly detection program 110a, 110b may implement the GUI 212 to present the candidate token probability score 238 in the source code file 214 via the programming tool 210. In some implementations, the GUI 212 may indicate the corresponding token associated with the candidate token probability score 238. According to one embodiment, the anomaly detection program 110a, 110b may implement the GUI 212 to present each token probability score in the source code file 214 via the programming tool 210. In some implementations, the GUI 212 may indicate each token probability score 240 adjacent the corresponding token.

According to one embodiment, the detected low probability regions 242 may be associated with the candidate token 224 satisfying the low probability threshold. As such, the detected low probability regions 242 may include one or more detected low probability tokens. In some embodiments, the detected low probability regions 242 may include multiple detected low probability tokens. In some embodiments, the detected low probability regions 242 may include one or more sequences of tokens 228 in the source code file 214.

According to one embodiment, the anomaly detection program 110a, 110b may implement the GUI 212 to present the detected low probability regions 242 as highlighted regions of source code in the source code file 214. In some implementations, the detected low probability regions 242 may be indicated to the user 208 (e.g., brought to the attention of the developer) in any suitable manner, such as, for example, underlined regions of source code, different font color regions of source code, and/or bold font regions of source code. Additionally, or alternatively, other graphically elements may also be implemented to indicate the detected low probability regions 242 to the user 208. According to one embodiment, the highlighted/indicated regions may inform the user as to one or more areas of the source code meriting further inspection.

According to one embodiment, the language model (e.g., trained ML model 216) constructed by the ML system 218 may include a generative language model. As a generative language model, the trained ML model 216 may generative one or more alternatives (e.g., generated alternative regions 244) to the detected low probability regions 242 of the target source code 226. In some implementations, the generated alternative regions 244 may include an alternative token to replace the candidate token 224 satisfying the low probability threshold. In some implementations, a determined probability of the alternative token in the sequence of tokens 228 may be relatively higher than the determined probability of the candidate token 224 satisfying the low probability threshold. In some embodiments, the GUI 212 may indicate the generated alternative regions 244 corresponding to the detected low probability regions 242 in the source code file 214. In some embodiments, the GUI 212 may enable the user 208 to modify the detected low probability regions 242 of the target source code 226 with the generated alternative regions 244. In some embodiments, once the target source code 226 is modified with the generated alternative regions 244 of higher probability tokens, the anomaly detection program 110a, 110b may determine the probability of each token (e.g., including the generated alternative token and/or the generated alternative regions 244) in the sequence of tokens 228 based on the context of other tokens (e.g., context tokens 230) in the sequence of tokens 228. As such, when modifications are made to the source code file 214 (e.g., including the target source code 226), the probability determination process can be repeated to determine if new concerns and/or anomalies are identified.

Referring now to FIG. 3, an operational flowchart illustrating the exemplary anomaly detection process 300 used by the anomaly detection program 110a, 110b according to at least one embodiment is depicted. According to one embodiment, FIG. 3 provides a general description of the anomaly detection process 300 with reference to the anomaly detection environment 200 in FIG. 2.

At 302, a target source code including a sequence of tokens is received. In one embodiment, the user 208 may interact with the programming tool 210 (e.g., via GUI 212) and select one or more section of source code from the source code file 214 for a review request. In some implementations, the user 208 (e.g., a developer) may select an arbitrary region of source code in the source code file 214 for analysis. In one embodiment, the anomaly detection program 110a, 110b may enable detecting the selected source code from the source code file 214 as the target source code 226 for the review request. In some implementations, the anomaly detection program 110a, 110b may enable the trained ML model 216 to receive the target source code 226 for anomaly detection. In some embodiments, the anomaly detection program 110a, 110b may transform (e.g., tokenize) the target source code 226 into the sequence of tokens 228.

Then at 304 a probability of a candidate token in the sequence of tokens is determined based on a context of tokens in the sequence of tokens. According to one embodiment, the trained ML model 216 may compute the probability of the candidate token 224 based on the context tokens 230, as described previously with reference to FIG. 2. For example, the trained ML model 216 may analyze a number of tokens on each side of the candidate token 224 in the sequence of tokens 228. In one embodiment, the context tokens 230 may include the preceding tokens 232 in the sequence of tokens 228. Additionally, or alternatively, the context tokens 230 may include the succeeding tokens 234 in the sequence of tokens 228. As such, the trained ML model 216 being presented with a first N number of tokens in the sequence of tokens 228, may generatively compute the probabilities of one or more potential next tokens (e.g., candidate token 224). In some embodiments, the trained ML model 216 may determine the probability of each token in the sequence of tokens 228 based on the context of other tokens (e.g., context tokens 230) in the sequence of tokens 228.

Thereafter at 306, in response to the determined probability of the candidate token satisfying a low probability threshold, a low probability region is detected in the received target source code, where the detected low probability region is associated with the one or more candidate tokens satisfying the low probability threshold. According to one embodiment, the trained ML model 216 may detect the low probability region in the sequence of tokens 228 based on the determined probability of the candidate tokens 224 satisfying a low probability threshold, as described previously with reference to FIG. 2. In some embodiments, the detected low probability region in the received target source code may be detected based on the determined probability of a corresponding token in the detected low probability region satisfying the low probability threshold.

In some implementations, if a candidate token 224 that is encountered in the sequence of tokens 228 is especially divergent from the expectations of the trained ML model 216 (e.g., anticipated token is different from candidate token 224), the trained ML model 216 may determine a low probability score for the candidate token 224 which satisfies the low probability threshold.

According to one embodiment, the language model (e.g., trained ML model 216) constructed by the ML system 218 may include a generative language model. As a generative language model, the trained ML model 216 may generative one or more alternatives (e.g., generated alternative regions 244) to the detected low probability regions 242 of the target source code 226. In some implementations, the generated alternative regions 244 may include an alternative token to replace the candidate token 224 satisfying the low probability threshold. In some implementations, a determined probability of the alternative token in the sequence of tokens 228 may be relatively higher than the determined probability of the candidate token 224 satisfying the low probability threshold.

In some embodiments, the anomaly detection program 110a, 110b may enable the user 208 to modify the detected low probability regions 242 of the target source code 226 with the generated alternative regions 244. In some embodiments, once the target source code 226 is modified with the generated alternative regions 244 of higher probability tokens, the anomaly detection program 110a, 110b may determine the probability of each token (e.g., including the generated alternative token and/or the generated alternative regions 244) in the sequence of tokens 228 based on the context of other tokens (e.g., context tokens 230) in the sequence of tokens 228. As such, when modifications are made to the source code file 214 (e.g., including the target source code 226), the probability determination process can be repeated to determine if new concerns and/or anomalies are identified.

Accordingly, the anomaly detection program 110a, 110b may improve the functionality of a computer because the anomaly detection program 110a, 110b may enable the computer to detect regions of programming language code (e.g., source code) containing deviations (e.g., errors, code smells, anti-patterns, style) from high-quality coding practices. As such, the functionality of the computer may be improved with higher quality programs instructing the computer.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the anomaly detection program 110a in client computer 102, and the anomaly detection program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the anomaly detection program 110a and 110b can be stored on one or more of the respective portable computer-readable tangible storage devices 920, read via the respective RAY drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the anomaly detection program 110a in client computer 102 and the anomaly detection program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the anomaly detection program 110a in client computer 102 and the anomaly detection program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

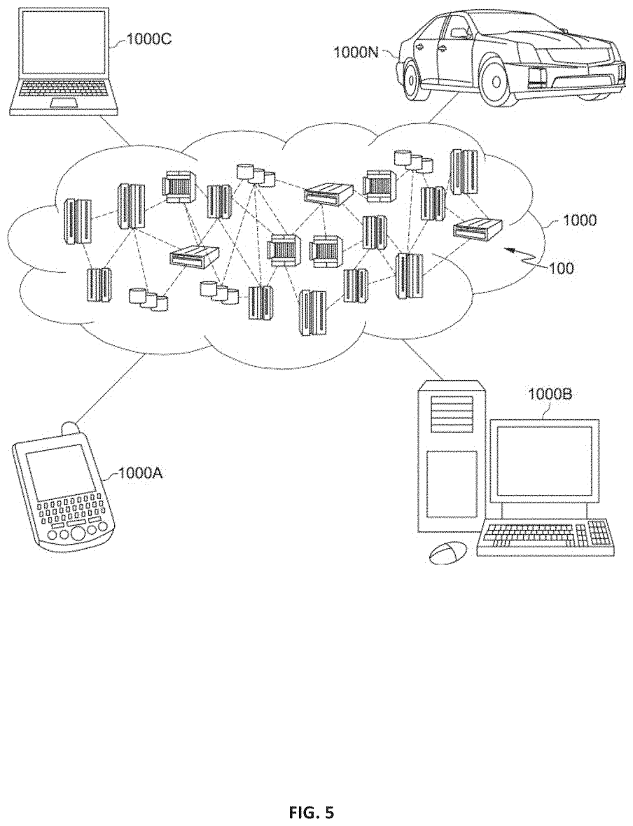

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

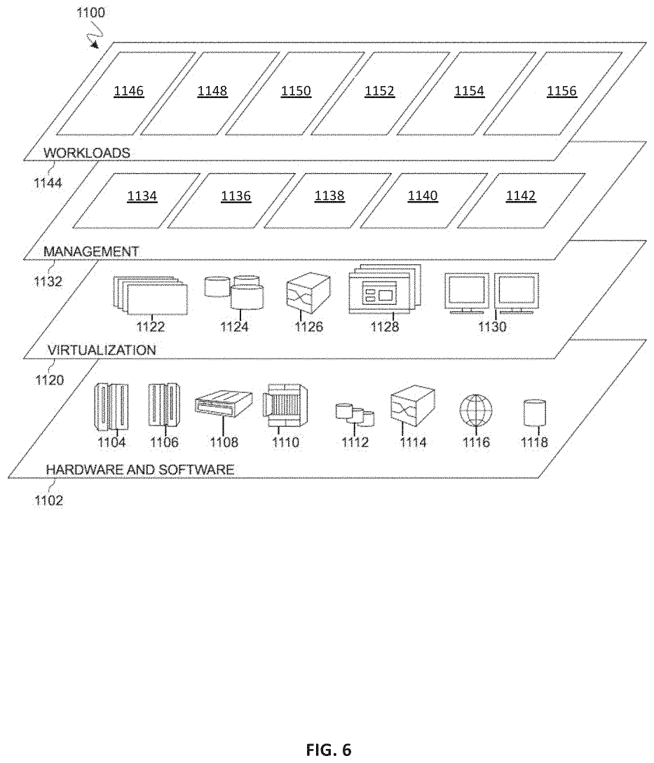

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and anomaly detection 1156. A anomaly detection program 110a, 110b provides a way to) to train a machine learning model (using self-supervised learning) to recognize the patterns and qualities of high-quality source code and detect if/when a source code under evaluation deviates from that high-quality standard.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a target source code including a sequence of tokens;
determining a probability of a candidate token in the sequence of tokens based on a context of other tokens in the sequence of tokens; and
in response to the determined probability of the candidate token satisfying a low probability threshold, detecting a low probability region in the received target source code, wherein the detected low probability region is associated with the candidate token satisfying the low probability threshold.

2. The method of claim 1, further comprising:
generating an alternative to the detected low probability region of the received target source code, wherein the generated alternative includes an alternative token to replace the candidate token in the sequence of tokens, wherein the determined probability of the alternative token in the sequence of tokens is relatively higher than the determined probability of the candidate token satisfying the low probability threshold.

3. The method of claim 2, further comprising:
modifying the received target source code based on the generated alternative to the detected low probability region of the received target source code; and
determining the probability of each token in the sequence of tokens based on the context of other tokens in the sequence of tokens, wherein the sequence of tokens in the modified target source code includes the alternative token.

4. The method of claim 1, wherein determining the probability of the candidate token in the sequence of tokens based on the context of other tokens in the sequence of tokens further comprises:
determining the probability of each token in the sequence of tokens based on the context of other tokens in the sequence of tokens.

5. The method of claim 4, wherein the detected low probability region in the received target source code is detected based on the determined probability of a corresponding token in the detected low probability region satisfying the low probability threshold.

6. The method of claim 1, wherein receiving the target source code including the sequence of tokens further comprises:
detecting a selection from a source code file, wherein the detected selection includes the target source code; and
receiving the detected selection from the source code file as the target source code for analysis.

7. The method of claim 1, wherein the context of other tokens in the sequence of tokens further comprises:
analyzing a number of tokens on each side of the candidate token in the sequence of tokens.

8. A computer system for software anomaly detection, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
receiving a target source code including a sequence of tokens;
determining a probability of a candidate token in the sequence of tokens based on a context of other tokens in the sequence of tokens; and
in response to the determined probability of the candidate token satisfying a low probability threshold, detecting a low probability region in the received target source code, wherein the detected low probability region is associated with the candidate token satisfying the low probability threshold.

9. The computer system of claim 8, further comprising:
generating an alternative to the detected low probability region of the received target source code, wherein the generated alternative includes an alternative token to replace the candidate token in the sequence of tokens, wherein the determined probability of the alternative token in the sequence of tokens is relatively higher than the determined probability of the candidate token satisfying the low probability threshold.

10. The computer system of claim 9, further comprising:
modifying the received target source code based on the generated alternative to the detected low probability region of the received target source code; and
determining the probability of each token in the sequence of tokens based on the context of other tokens in the sequence of tokens, wherein the sequence of tokens in the modified target source code includes the alternative token.

11. The computer system of claim 8, wherein determining the probability of the candidate token in the sequence of tokens based on the context of other tokens in the sequence of tokens further comprises:
determining the probability of each token in the sequence of tokens based on the context of other tokens in the sequence of tokens.

12. The computer system of claim 11, wherein the detected low probability region in the received target source code is detected based on the determined probability of a corresponding token in the detected low probability region satisfying the low probability threshold.

13. The computer system of claim 8, wherein receiving the target source code including the sequence of tokens further comprises:
detecting a selection from a source code file, wherein the detected selection includes the target source code; and
receiving the detected selection from the source code file as the target source code for analysis.

14. The computer system of claim 8, wherein the context of other tokens in the sequence of tokens further comprises:
analyzing a number of tokens on each side of the candidate token in the sequence of tokens.

15. A computer program product for software anomaly detection, comprising:
one or more computer-readable storage media and program instructions collectively stored on the one or more computer-readable storage media, the program instructions executable by a processor to cause the processor to perform a method comprising:
receiving a target source code including a sequence of tokens;
determining a probability of a candidate token in the sequence of tokens based on a context of other tokens in the sequence of tokens; and
in response to the determined probability of the candidate token satisfying a low probability threshold, detecting a low probability region in the received target source code, wherein the detected low probability region is associated with the candidate token satisfying the low probability threshold.

16. The computer program product of claim 15, further comprising:
generating an alternative to the detected low probability region of the received target source code, wherein the generated alternative includes an alternative token to replace the candidate token in the sequence of tokens, wherein the determined probability of the alternative token in the sequence of tokens is relatively higher than the determined probability of the candidate token satisfying the low probability threshold.

17. The computer program product of claim 16, further comprising:
modifying the received target source code based on the generated alternative to the detected low probability region of the received target source code; and
determining the probability of each token in the sequence of tokens based on the context of other tokens in the sequence of tokens, wherein the sequence of tokens in the modified target source code includes the alternative token.

18. The computer program product of claim 15, wherein determining the probability of the candidate token in the sequence of tokens based on the context of other tokens in the sequence of tokens further comprises:
determining the probability of each token in the sequence of tokens based on the context of other tokens in the sequence of tokens.

19. The computer program product of claim 18, wherein the detected low probability region in the received target source code is detected based on the determined probability of a corresponding token in the detected low probability region satisfying the low probability threshold.

20. The computer program product of claim 15, wherein receiving the target source code including the sequence of tokens further comprises:
detecting a selection from a source code file, wherein the detected selection includes the target source code; and
receiving the detected selection from the source code file as the target source code for analysis.
